(19) United States
(12) Patent Application Publication
(10) Pub. No.: US 2026/0072665 A1
(43) Pub. Date: Mar. 12, 2026

(54) Using a Tested Software Bill-of-Materials (TSBOM) for Installing and Executing a Software Application

(71) Applicant: MICRO FOCUS LLC, WILMINGTON, DE (US)

(72) Inventors: DOUGLAS MAX GROVER, RIGBY, ID (US); MICHAEL F. ANGELO, HOUSTON, TX (US)

(73) Assignee: MICRO FOCUS LLC, WILMINGTON, DE (US)

(21) Appl. No.: 18/830,514

(22) Filed: Sep. 10, 2024

(51) Int. Cl. G06F 8/61

(52) U.S. Cl. CPC G06F 8/61

(57) ABSTRACT

A determination is made that a software application is one of being installed in an installation environment or executed in an execution environment. In response to determining that the software application is one of being installed in the installation environment or executed in the execution environment, a Tested Software Bill-of-Materials (TSBOM) of the software application is retrieved. The TSBOM of the software application is a list of tested software components that are executed during testing of the software application. A determination is made that software components in the installation environment or in the execution environment matches the list of tested software components. In response to determining that at least one of the software components in the installation environment or in the execution environment does not match the tested software components in the list of tested software components, a notification is generated.

### FIELD

The disclosure relates generally to tracking software components and particularly to tracking software components for a tested software application in an installation/execution environment.

### BACKGROUND

There are a lot of concerns with getting an accurate Software Bill-of-Materials (SBOM). Inaccurate SBOMs can lead to security breaches because software components may be missing from the SBOM, and those components may have vulnerabilities. While SBOMs are valuable in identifying vulnerabilities in software applications, there are still limitations with them. For example, the execution environment of a software application may use component versions, or third-party dependencies that are different from those in the testing environment. In the case of the third-party dependencies, they are not included in the SBOM. An example is where a software application may have been tested with a third-party library that is different than the version of library that is actually installed and executed (e.g., consider dynamic libraries). Another issue is that an SBOM does not directly include libraries or environment components as they are provided by the environment.

Differences between the execution environment, the testing environment, and the SBOM can lead to attacks on the supply chain. These inconsistencies, between the SBOM and the tested execution environment, can lead to vulnerabilities in the supply chain of the software application, which is undesirable.

### SUMMARY

These and other needs are addressed by the various embodiments and configurations of the present disclosure. The present disclosure can provide a number of advantages depending on the particular configuration. These and other advantages will be apparent from the disclosure contained herein.

A determination is made that a software application is one of being installed in an installation environment or executed in an execution environment. In response to determining that the software application is one of being installed in the installation environment or executed in the execution environment, a Tested Software Bill-of-Materials (TSBOM) of the software application is retrieved. The TSBOM of the software application is a list of tested software components that are used or were present in the test environment while the product was being tested. A determination is made that software components in the installation environment or in the execution environment matches the list of tested software components. In response to determining that at least one of the software components in the installation environment or in the execution environment does not match the tested software components in the list of tested software components, a notification is generated that indicates that the at least one of the software components in the installation environment or in the execution environment does not match the installation environment or the execution environment.

The phrases “at least one”, “one or more”, “or,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine,” “calculate” and “compute,” and variations thereof, as used herein, are used interchangeably, and include any type of methodology, process, mathematical operation, or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The term “blockchain” as described herein and in the claims refers to a growing list of records, called blocks, which are linked using cryptography. The blockchain is commonly a decentralized, distributed and public digital ledger that is used to record transactions across many computers so that the record cannot be altered retroactively without the alteration of all subsequent blocks and the consensus of the network. Each block contains a cryptographic hash of the previous block, a timestamp, and transaction data (generally represented as a merkle tree root hash). For use as a distributed ledger, a blockchain is typically managed by a peer-to-peer network collectively adhering to a protocol for inter-node communication and validating new blocks. Once recorded, the data in any given block cannot be altered retroactively without alteration of all subsequent blocks, which requires consensus of the network majority. In verifying or validating a block in the blockchain, a hashcash algorithm generally requires the following parameters: a service string, a nonce, and a counter. The service string can be encoded in the block header data structure, and include a version field, the hash of the previous block, the root hash of the merkle tree of all transactions (or information or data) in the block, the current time, and the difficulty level. The nonce can be stored in an extraNonce field, which is stored as the left most leaf node in the merkle tree. The counter parameter is often small at 32-bits so each time it wraps the extraNonce field must be incremented (or otherwise changed) to avoid repeating work. When validating or verifying a block, the hashcash algorithm repeatedly hashes the block header while incrementing the counter & extraNonce fields. Incrementing the extraNonce field entails recomputing the merkle tree, as the transaction or other information is the left most leaf node. The body of the block contains the transactions or other information. These are hashed only indirectly through the Merkle root.

As defined herein, the term “software” may include not only software but may also include firmware.

As defined herein, the term “software component” may include files such as libraries, executables, dependent software components, configuration files, operating systems, virtual machines, containers, linker/loaders, environmental component(s) (could include hardware), and/or the like.

As defined herein, the term “execution” and its variants may include execution of a binary, interpretation of source code (e.g., a Java Virtual Machine (JVM) running source code), loading of a binary, loading of source code, loading of a configuration file, reading a configuration file, and/or the like.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a block diagram of a first illustrative system for using a Tested Software Bill-of-Materials (TSBOM).

FIG. 2 is a block diagram of a process for using a TSBOM during installation of a software application.

FIG. 3 is a block diagram of a process for using a TSBOM during the loading/interpretation/execution of a software application.

FIG. 4 is a flow diagram of a process for using a TSBOM in an installation environment.

FIG. 5 is a flow diagram of a process for using a TSBOM in an execution environment.

FIG. 6 is a diagram of a user interface of identified issues with software components during an installation of a software application.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

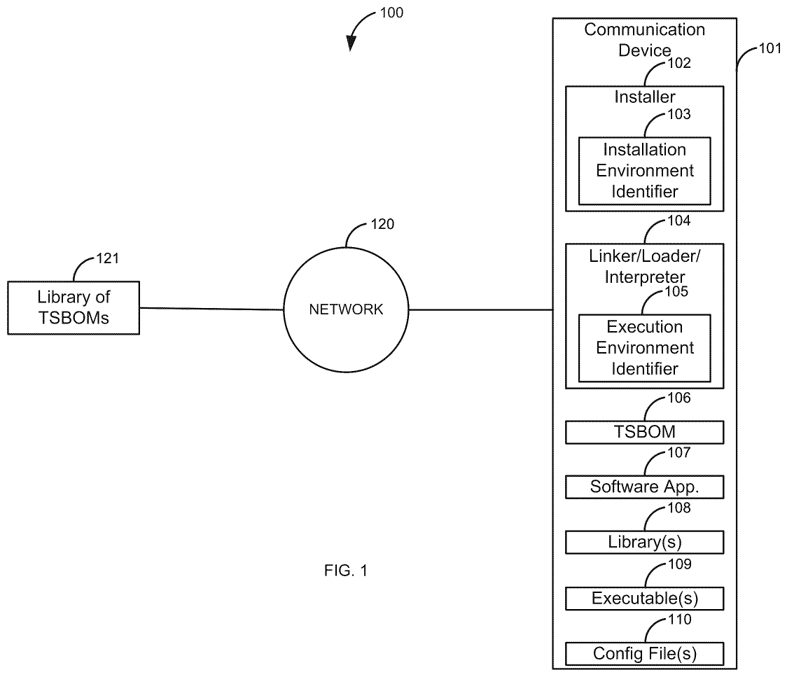

FIG. 1 is a block diagram of a first illustrative system 100 for using a Tested Software Bill-of-Materials (TSBOM) 106. The first illustrative system 100 comprises a communication device 101, a network 120, and a library of TSBOMs 121.

The communication device 101 can be or may include any device that can run a software application 107, such as a Personal Computer (PC), a telephone, a video system, a cellular telephone, a Personal Digital Assistant (PDA), a tablet device, a notebook device, a laptop computer, a smartphone, a server, an embedded device, and/or the like. Although FIG. 1 only shows a single communication device 101, any number of communication devices 101 may be connected to the network 110. The communication device 101 further comprises an installer 102, a loader/linker/interpreter 104, a TSBOM 106, a software application 107, library(s) 108, executable(s) 109, and configuration file(s) 110.

The installer 102 can be any software that is used to install the software application 107 into an installation environment. The installer 102 may install various software components of the software application 107 into the installation environment. The installer 102 further comprises an installation environment identifier 103. The installation environment identifier 103 is used to identify the software components of the software application 107 being installed and to any library(s) 108, executable(s) 109, and/or configuration files 110 necessary to execute the software application 107.

The linker/loader/interpreter 104 can be any software that is used to execute/load the software application 107. For example, for binary file(s), a linker/loader 104 may load and execute the binary file(s). For interpreted programs (e.g., Java), an interpreter 104 (e.g., a Java Virtual Machine (JVM)) may interpret the source code as part of the execution process. The linker/loader/interpreter 104 further comprises an execution environment identifier 105. The execution environment identifier 105 is used to identify all the software components, library(s) 108, executable(s) 109, configuration file(s) 110 that are needed to load/execute/interpret the software application 107.

The TSBOM 106 is a list of tested software components for the software application 107. The TSBOM 106 may include various types of information, such as a software component name, a version number, vulnerability(s) of the software component, incompatibility(s) between software components, use policy(s), hashes of the software component, and/or the like. Below is an example of a TSBOM 106.

### Example TSBOM 106

| Software | | | | |
|---|---|---|---|---|
| Component | Version | Vulnerability(s) | Incompatibility(s) | Use Policy |
| Component A | 1.0 | Backdoor Password | None | Use Not |
| | | | | Recommended |
| Component A | 1.11 | None | None | Can Use |
| Component A | 2.0 | None | Missing API X | Cannot Use |
| Component B | 3.2 | None | None | Can Use |
| Component C | 4.0 | Memory Corruption | None | Can Use |
| Library D | 3.0 | Buffer Overflow, | None | Use Not |
| | | SQL Injection | | Recommended |
| Library D | 4.0 | None | None | Can Use |
| Executable E | 2.3 | None | None | Can Use |
| Linux | 5.0 | None | None | Can Use |
| Linux | 5.1 | None | None | Can Use |
| Kubernetes | 2.0 | None | None | Can Use |
| (Container) | | | | |
| Static | 1.0 | None | None | Verify if |
| Configuration | | | | Changed |
| File F | | | | |
| . . . | . . . | . . . | . . . | . . . |
| Component N | 2.1 | Low Encryption (56- | None | Implementation |
| | | Bit Encryption) | | Dependent |
| Component N | 3.0 | None | None | Can Use |

The example TSBOM 106 shows the software components A through N of the software application have been executed and tested. For example, for the software component A, versions 1.0, 1.11, and 2.0 were tested. Software component A, version 1.0 has a backdoor password vulnerability and is not recommended to be used (a policy). Version 1.11 can be used, and version 2.0 is incompatible because API X is missing and cannot be used. For software component B, only version 3.2 was tested. Version 3.2 does not have any vulnerabilities or incompatibilities and can be used. The software component C, version 4.0 has been tested and has a memory corruption vulnerability. However, the memory corruption issue is a low-level vulnerability and version 4.0 can be used. Library 108D (a software component), versions 3.0 and 4.0 have been tested. However, version 3.0 is not recommended because of a buffer overflow vulnerability and a SQL injection vulnerability. Version 4.0 can be used.

Executable 109E (a software component) version 2.3 has been tested and can be used. Linux versions 5.0 and 5.1 have been tested and either can be used. The Kubernetes version 2.0 was tested and can be used. The static configuration file 110F can be installed into the installation environment 201 and the policy is to validate that the static configuration file 110F has not changed (e.g., when executed) using the hash in the TSBOM 106. Component N, versions 2.1 and 3.0 have been tested. Version 2.1 has low encryption (56-Bit) and may be vulnerable based on the implementation. Version 3.0 can be used.

In one embodiment, the TSBOM 106 may be stored in an individual blockchain or in a blockchain based on a plurality of TSBOMs 106 for all the software applications 107 that will be installed/executed/interpreted in a specific execution environment 301 (e.g., in a virtual machine, a container, in a cloud service, and/or a specific operating system/virtual machine, and/or the like). Thus, when the linker/loader/interpreter 104 tries to execute any software application 107, the linker/loader/interpreter can get the correct TSBOM 106 for the current software application 107 that is being loaded/interpreted from the blockchain. When a software application 107 is installed, the blockchain is updated with a new block that comprises the TSBOM 106 for the newly installed software application 107.

The software application 107 can be or may include any type of software application 107, such as a database application, a security application, a network application, an embedded application, a word processing application, a spreadsheet application, a cloud application, a networked application, a communications application, a financial application, a human resource application, and/or the like. The software application 107 may comprise multiple different software applications 107.

The library(s) 108 may be any type of library 108, such as a dynamically linked library, a runtime library, a dependent library, a class library, and/or the like. The library(s) 108 may include multiple libraries 108 that are used by multiple software applications 107.

The executable(s) 109 are separately executable files (e.g., a binary) that are executed by the software application 107. The executable(s) 109 may be executed by different software applications 107.

The configuration file(s) 110 are static files that are used by the software application 107 to configure the software application 107.

The network 110 can be or may include any collection of communication equipment that can send and receive electronic communications, such as the Internet, a Wide Area Network (WAN), a Local Area Network (LAN), a packet switched network, a circuit switched network, a cellular network, a combination of these, and the like. The network 110 can use a variety of electronic protocols, such as Ethernet, Internet Protocol (IP), Hyper Text Transfer Protocol (HTTP), Web Real-Time Protocol (Web RTC), and/or the like. Thus, the network 110 is an electronic communication network configured to carry messages via packets and/or circuit switched communications.

The library of TSBOMs 121 is a library of multiple different TSBOMs 106 that can be accessed either by the installer 102 and/or the linker/loader/interpreter 104 in real-time. This allows for more up to date TSBOMs 106. For example, if a new version of Linux becomes available and has been tested with the software application 107, the updated TSBOM 106 can be uploaded to the library of TSBOMs 121. This allows for more up to date TSBOMs 106 to be retrieved during the execution/installation process.

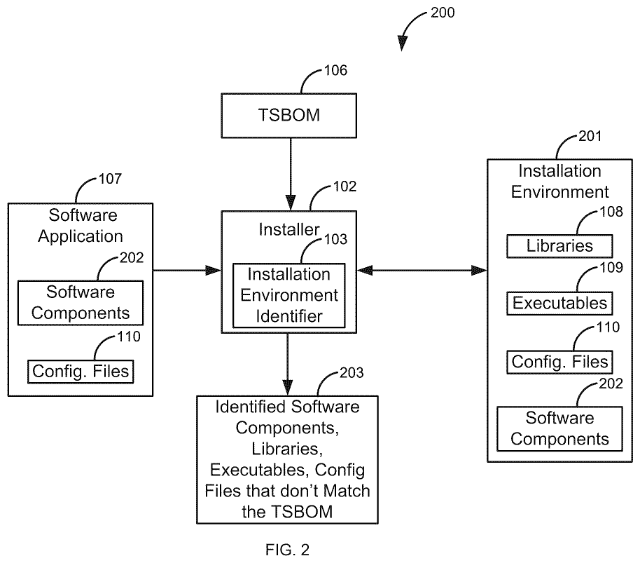

FIG. 2 is a block diagram 200 of a process for using a TSBOM 106 during installation of a software application 107. Instead of just creating a Software Bill-of-Materials (SBOM), a TSBOM 106 for the software application 107 is created. In addition to the regular information in a SBOM, the TSBOM 106 includes all the software components that were used when testing the complete software application 107. The TSBOM 106 may include software components of the software application 107, the different versions of libraries 108 that were used to test the software application 107, any versions of other executables 109 that are executed by the software application 107, static configuration files 110, and/or the like. For example, if the software application 107 was tested with library 108Y, versions 1.0, 1.1, and 2.0, the TSBOM 106 will include the SBOM information for the library 108Y, versions 1.0, 1.1, and 2.0. The TSBOM 106 also has hashes (e.g., a forward and/or reverse hashes) of the different software components/libraries 108/executables 109/configuration files 110 that were tested. The hashes may be based on different hashing algorithms.

The TSBOM 106 may also include dependencies. For example, if library 108Y calls library 108Z, the TSBOM 106 may also include the versions of library 108Z that the software application 107 was tested with. Thus, the whole dependency tree of the software application 107 in the TSBOM 106 can include all the dependent software components 202 that were tested along with any dependencies that are incompatible/have known vulnerabilities. Each of the software components 202 for the dependencies can have associated hash(s) in the TSBOM 106 to verify the correct version(s).

The installer 102, gets the software components 202 of the software application 107/configuration files 110 and installs the software components 202 of the software application 107/configuration files 110 into the installation environment 201. The TSBOM 106 is used as an input once the software application 107 is ready to be installed (or during installation). In one embodiment, the TSBOM 106 may be included as part of the installer 102/installation package. In another embodiment, the installer 102 may get the TSBOM 106 from the library of TSBOMs 121 in real-time.

The installation environment identifier 103 identifies the software components 202 of the software application 107, the libraries 108, the executables 109, and/or configuration files 110 that are going to be used by the software application 107 in the installation environment 201. The installation environment 201 is the environment where the software application 107 is installed. The installation environment 201 may vary depending on the software application 107 and where the software application 107 is being installed. For example, the installation environment 201 may include an operating system, a java virtual machine, a container, an interpreter 104, a linker/loader 104, the libraries 108, the executables 109, the configuration files 110, and/or the like.

If there are any software component(s) 202, libraries 108, executables 109, and/or configuration file(s) 110 that do not match the TSBOM 106, the installation environment identifier 103 identifies the software components 202, the libraries 108, the executables 109, and/or the configuration files 110 in the installation environment 201 that do not match the TSBOM 106 (block 203). The identified software components 202, the libraries 108, the executables 109, and/or the configuration files 110 in the installation environment 201 that do not match the TSBOM 106 (block 203) may be identified based on various reasons, such as where the installed software application 107 will be using a library 108 that has not been tested, where the installed software application 107 will be using a library 108 that is incompatible or has a known vulnerability, where a checksum of an software component 202/existing library 108/configuration file 110 does not match what is in the TSBOM 106, and/or the like.

The installation environment identifier 103 may identify the software components 202, the libraries 108, the executables 109, and/or the configuration files 110 in the installation environment 201 that do not match the TSBOM 106 (block 203) based on known paths/relative paths where the software components 202, the libraries 108, the executables 109, and/or the configuration files 110 are stored. The installation environment identifier 103 may use linker information to identify the locations/versions of the libraries 108, executables 109, configuration files 110, and/or the like.

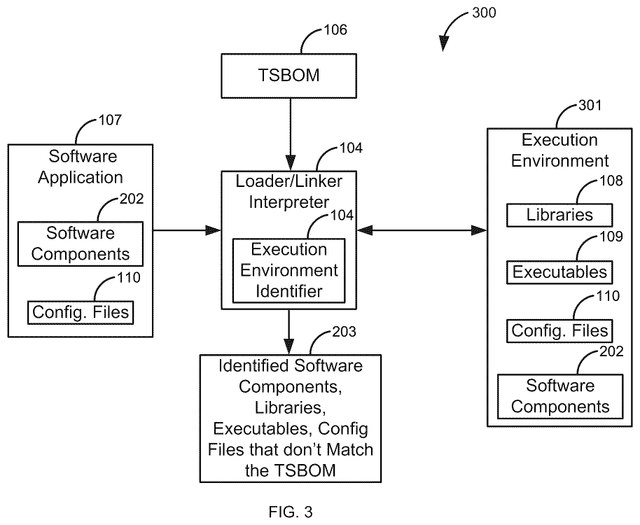

FIG. 3 is a block diagram 300 of a process for using a TSBOM 106 during the loading/interpretation/execution of a software application 107. FIG. 3 illustrates how the TSBOM 106 can be applied when the software application 107 is executed.

The loader/linker/interpreter 104 uses the TSBOM 106 to identify what software components 202 (e.g., the libraries 108, the executables 109, and/or configuration files 110) will be executed. This process will work for interpreted files (e.g., Java source code), binaries (loaded by the loader/linker 104), and/or the like. The execution environment identifier 105 identifies which software components 202, libraries 108, executables 109, and/or configuration files 110 will be loaded/executed/interpreted in the execution environment 301 and then compares what is going to be loaded/executed/interpreted to what is in the TSBOM 106. The execution environment 301 may vary depending on how the software application 107 was installed. The execution environment 301 may be the same as the installation environment 201 or may vary over time from the installation environment 201 as the libraries 108/executables change over time.

If there are software components 202, libraries 108, executables 109, and/or configuration files 110 that do not match the TSBOM 106, these can be identified as having potential issues (block 203). Depending on the type of issue, the identified issue(s) may cause the loader/linker/interpreter 104 to not load/execute/interpret the software application 107. Another option may be to notify a user and give the user the option of allowing the loading/executing/interpreting of the software application 107.

A key advantage of using the TSBOM 106 during the execution/interpretation process is that if a library 108, an executable 109, a configuration file 110 (one that is supposed to be static) gets updated/changed after the software application 107 is installed, the TSBOM 106 can be used to identify if the software application 107 has been tested with the updated/changed version of library 108, executable 109, and/or configuration file 110. If the updated/changed version is in the TSBOM 106, the execution/interpretation will proceed as normal. If there is an issue (e.g., a software component now has not been tested, is incompatible, or has a vulnerability), it can be flagged, and the administrator can be notified. In one embodiment/option, the administrator can then determine whether to allow the software application 107 to be loaded/executed/interpreted.

In addition, this process may occur periodically or on demand even if the software application 107 is not being executed. Periodic review of the execution environment 301 (after install if not being used) may occur to identify changes in the execution environment 301. Alternatively, if a change to the execution environment 301 occurs, the process of checking the execution environment 301 to the TSBOM 106 can automatically occur.

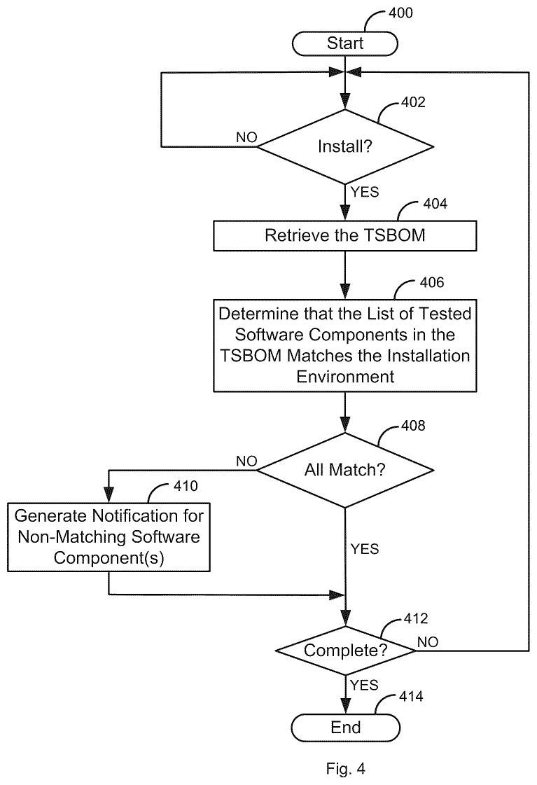

FIG. 4 is a flow diagram of a process for using a TSBOM 106 in an installation environment 201. Illustratively, the communication device 101, the installer 102, the installation environment identifier 103, the linker/loader/interpreter 104, the execution environment identifier 105, the software application 107, the library(s) 108, the executable(s) 109, and the library of TSBOMs 121, are stored-program-controlled entities, such as a computer or microprocessor, which performs the method of FIGS. 4-6 and the processes described herein by executing program instructions stored in a computer readable storage medium, such as a memory (i.e., a computer memory, a hard disk, and/or the like). Although the methods described in FIGS. 4-6 are shown in a specific order, one of skill in the art would recognize that the steps in FIGS. 4-6 may be implemented in different orders and/or be implemented in a multi-threaded environment. Moreover, various steps may be omitted or added based on implementation.

The process starts in step 400. The installer 102 determines, if a request to install the software application 107 has been received in step 402. If a request has not been received in step 402, the process of step 402 repeats.

Otherwise, if the request to install the software application 107 has been received in step 402, the installer 102 retrieves the TSBOM 106 for the software application 107 in step 404. For example, the installer 102 may retrieve the TSBOM 106 for the software application 107 from the library of TSBOMs 121 in step 404.

The installation environment identifier 103 determines, in step 406, if the list of tested software components 202 in the TSBOM 106 (e.g., the software components 202, the library(s) 108, the executable(s) 109, and/or the configuration files 110) matches the installation environment 201. If any the software components 202/libraries 108/executables 109 in the installation environment 201 do not match the TSBOM 106 in step 408, the installation environment identifier 103 generates a notification for the non-matching software components 202 in step 410 and the process goes to step 412. The notification of step 410 may be used to block of the installation process of the software application 107, displayed a user interface that allows a user to take an action, and/or the like. Otherwise, if list of tested software components in the TSBOM 106 matches the installation environment 201 in step 408, the process goes to step 412.

The installation environment identifier 103 determines, in step 412, if the process is complete. If the process is not complete in step 412, the process goes back to step 402. Otherwise, the process ends in step 414.

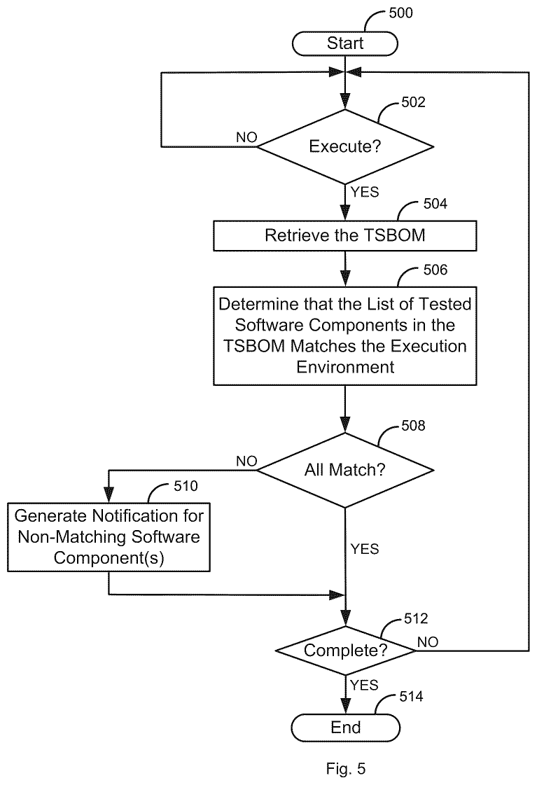

FIG. 5 is a flow diagram of a process for using a TSBOM 106 in an execution environment 301. The process starts in step 500. The linker/loader/interpreter 104 determines if a request to execute the software application 107 has been received in step 502. If the request has not been received in step 502, the process of step 502 repeats.

Otherwise, if the request to execute the software application 107 has been received in step 502, the linker loader/interpreter 104 retrieves the TSBOM 106 for the software application 107 in step 504. For example, the linker loader/interpreter 104 may retrieve the TSBOM 106 for the software application 107 locally on the communication device 101.

The execution environment identifier 105 determines, in step 506, if the list of tested software components 202 in the TSBOM 106 (e.g., the software components 202, the library(s) 108, the executable(s) 109, and/or the configuration files 110) matches the execution environment 301. If any the software components 202 in the execution environment 301 do not match in step 508, the execution environment identifier 105 generates a notification for the non-matching software component(s) 202 in step 510 and the process goes to step 512. In addition, the notification of step 510 may be used to block execution of the software application 107, block loading of the software application 107, display a user interface that allows a user to take an action, and/or the like. Otherwise, if list of tested software components in the TSBOM 106 matches the execution environment 301 in step 508, the process goes to step 512.

The installation environment identifier 103 determines, in step 512, if the process is complete. If the process is not complete in step 512, the process goes back to step 502. Otherwise, the process ends in step 514.

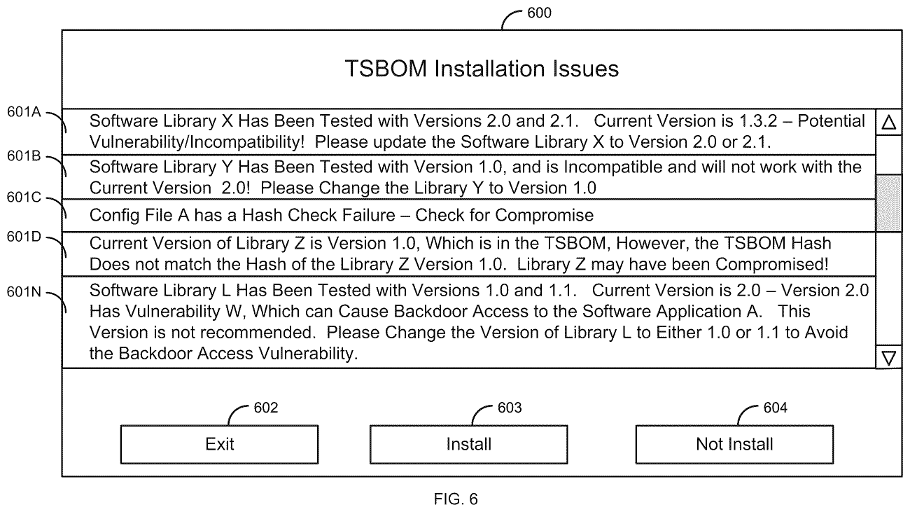

FIG. 6 is a diagram of a user interface 600 of identified issues 601A-601N with software components 202 during an installation of a software application 107. The user interface 600 may be displayed based on various issues 601, criteria, thresholds, and/or the like. For example, the user interface 600 may be displayed based on an identified issue 601 (e.g., a vulnerability, an incompatibility, a checksum failure when checking a software component 202/configuration file 110, a level of an identified issue 601, a threshold of summed issues 601, and/or the like). While FIG. 6 is shown as part of an installation environment 201, similar issues 601 may be identified in the execution environment 301.

The similar issues 601 identified in the execution environment 301 may be displayed in the user interface 600 based on similar issues 601, criteria, thresholds, and/or the like. In addition, in the execution environment 301, if there is an issue 601 that identifies a new version of a software component 202 that has not been tested, the user may be given the option to proceed to see if the software application 107 can still be executed.

The user interface 600 shows issues 601A-601N that have been identified based on the installation of the software application 107. The first issue 601A is where the software application 107 was tested with versions 2.0 and 2.1 of library 108X, but the current version of library 108X in the installation environment 201 is version 1.3.2. The recommendation is to update to either of the versions 2.0 or 2.1 of library 108X. The second issue 601B is that the software application 107 has been tested with version 1.0 of library 108Y, and the current version of library 108Y is 2.0, which is incompatible. The recommendation is to change back to version 1.0 of library 108Y. The third issue 601C is where the configuration file 110A has a hash check failure. The fourth issue 601D is where the current version of the library 108Z is version 1.0, which is in the TSBOM 106. However, the hash in the TSBOM 106 does not match the current hash of library 108Z in the installation environment 201. The last issue 601N is where the software application 107 has been tested with versions 1.0 and 1.1 of library 108L. The current version of library 108L is 2.0. Version 2.0 of library 108L has vulnerability W, which can cause backdoor access to the software application 107. Version 2.0 of library 108L is not recommended.

The user/administrator may opt to not install the software application 107 using the not install button 604. The user may elect to install by clicking on the install button 603. Alternatively, the user/administrator may exit by clicking on the exit button 602.

If the user interface 600 is for the execution environment 301, the user may elect to not load/execute the software application 107 based on what issues 601 were identified. In addition, the user may have the option to proceed with execution if a new version of a software component 202 is identified in the execution environment 301. It can be flagged if the new version of the software component cannot be executed.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, sub combinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A system comprising:
a microprocessor; and
a computer readable medium, coupled with the microprocessor and comprising microprocessor readable and executable instructions that, when executed by the microprocessor, cause the microprocessor to:
determine that a software application is one of being installed in an installation environment or executed in an execution environment;
in response to determining that the software application is one of being installed in the installation environment or executed in the execution environment, retrieve a Tested Software Bill-of-Materials (TSBOM) of the software application, wherein the TSBOM of the software application is a list of tested software components, wherein a tested software component is executed during testing of the software application;
determine that software components in the installation environment or in the execution environment matches the list of tested software components; and
in response to determining that at least one of the software components in the installation environment or in the execution environment does not match the tested software components in the list of tested software components, generate a notification indicating that the at least one of the software components in the installation environment or in the execution environment does not match the installation environment or the execution environment.

2. The system of claim 1, wherein the software application is being installed in the installation environment.

3. The system of claim 1, wherein the software application is being executed in the execution environment.

4. The system of claim 3, wherein determining that the software components in the execution environment matches the list of software components further comprises at least one of: periodically determining that the software components in the execution environment matches the list of software components, determining that the software components in the execution environment matches the list of software components based on a change to the execution environment, and determining that the software components in the execution environment matches the list of software components on demand.

5. The system of claim 1, wherein the TSBOM comprises a first tested software component that comprises multiple tested versions of the first tested software component.

6. The system of claim 1, wherein retrieving the TSBOM comprises retrieving the TSBOM from a library of TSBOMs on a network and wherein the TSBOM in the library of TSBMOs is updated when one or more of the tested software components have been tested with a new version of the one or more tested software components.

7. The system of claim 6, wherein an installer, loader, linker, or interpreter gets the TSBOM from the library of TSBOMs on the network when determining that the software application is being executed in the execution environment.

8. The system of claim 6, wherein the TSBOM is stored in a blockchain for the library of TSBOMs.

9. The system of claim 8, wherein a block is added to the blockchain when the TSBOM is updated with the new version of the one or more tested software components.

10. The system of claim 1, wherein the notification indicating that the at least one of the tested software components does not match the installation environment or the execution environment is at least one of: displayed in a user interface, used to block installation of the software application, and used to block execution of the of the software application.

11. A method comprising:
determining, by a microprocessor, that a software application is one of being installed in an installation environment or executed in an execution environment;
in response to determining that the software application is one of being installed in the installation environment or executed in the execution environment, retrieving, by the microprocessor, a Tested Software Bill-of-Materials (TSBOM) of the software application, wherein the TSBOM of the software application is a list of tested software components, wherein a tested software component is executed during testing of the software application;
determining, by the microprocessor, that software components in the installation environment or in the execution environment matches the list of tested software components; and
in response to determining that at least one of the software components in the installation environment or in the execution environment does not match the tested software components in the list of tested software components, generating, by the microprocessor, a notification indicating that the at least one of the software components in the installation environment or in the execution environment does not match the installation environment or the execution environment.

12. The method of claim 11, wherein the software application is being installed in the installation environment.

13. The method of claim 11, wherein the software application is being executed in the execution environment.

14. The method of claim 13, wherein determining that the software components in the execution environment matches the list of software components further comprises at least one of: periodically determining that the software components in the execution environment matches the list of software components, determining that the software components in the execution environment matches the list of software components based on a change to the execution environment, and determining that the software components in the execution environment matches the list of software components on demand.

15. The method of claim 11, wherein the TSBOM comprises a first tested software component that comprises multiple tested versions of the first tested software component.

16. The method of claim 11, wherein retrieving the TSBOM comprises retrieving the TSBOM from a library of TSBOMs on a network and wherein the TSBOM in the library of TSBMOs is updated when one or more of the tested software components have been tested with a new version of the one or more tested software components.

17. The method of claim 16, wherein an installer, loader, linker, or interpreter gets the TSBOM from the library of TSBOMs on the network when determining that the software application is being executed in the execution environment.

18. The method of claim 16, wherein the TSBOM is stored in a blockchain for the library of TSBOMs.

19. The method of claim 11, wherein the notification indicating that the at least one of the tested software components does not match the installation environment or the execution environment is at least one of: displayed in a user interface, used to block installation of the software application, and used to block execution of the of the software application.

20. A non-transient computer readable medium having stored thereon instructions that cause a processor to execute a method, the method comprising instructions to:
determine that a software application is one of being installed in an installation environment or executed in an execution environment;
in response to determining that the software application is one of being installed in the installation environment or executed in the execution environment, retrieve a Tested Software Bill-of-Materials (TSBOM) of the software application, wherein the TSBOM of the software application is a list of tested software components, wherein a tested software component is executed during testing of the software application;
determine that software components in the installation environment or in the execution environment matches the list of tested software components; and
in response to determining that at least one of the software components in the installation environment or in the execution environment does not match the tested software components in the list of tested software components, generate a notification indicating that the at least one of the software components in the installation environment or in the execution environment does not match the installation environment or the execution environment.
